(19) United States
(12) Patent Application Publication
(10) Pub. No.: US 2024/0099283 A1
(43) Pub. Date: Mar. 28, 2024

(54) HANDLE KNOB WITH NO FREE PLAY

(71) Applicant: Pure Fishing, Inc., Spirit Lake, IA (US)

(72) Inventor: Cameron Ivie, Irmo, SC (US)

(21) Appl. No.: 18/264,285

(22) PCT Filed: Feb. 3, 2022
(86) PCT No.: PCT/US2022/015027

§ 371 Date: Aug. 4, 2023

Related U.S. Application Data
(60) Provisional application No. 63/145,834, filed on Feb. 4, 2021.

(51) Int. Cl. A01K 89/00

(52) U.S. Cl. CPC A01K 89/006

(57) ABSTRACT

A system is provided for reducing or eliminating free play in the handle knob of a fishing reel. The system provides for several embodiments wherein free play is reduced in the handle knob by eliminating the space or gap between a bearing and screw in the shaft of the handle knob. In one embodiment, living springs may be used to provide an upward force pressing the bearing and screw together and prevent axial movement of the bearing. In an exemplary embodiment, the addition of a protrusion in the interior housing of the knob handle may further reduce radial movement of the bearing. In another exemplary embodiment, elastomeric material may provide an upward pressure to a first bearing and downward pressure to a second bearing. In a final exemplary embodiment, a cap may be placed on the top of the screw, causing a downward pressure to reduce axial free play.

### CROSS-REFERENCE TO RELATED APPLICATIONS

This application is a U.S. National Phase Application of International Application No. PCT/US2022/015027 filed on Feb. 3, 2022, which claims the benefit of priority from U.S. Provisional Patent Application Ser. No. 63/145,834, filed on Feb. 4, 2021. The disclosures of PCT/US2022/015027 and 63/145,834 are incorporated herein by reference.

### FIELD OF THE INVENTION

The present invention is generally directed to handle knob for a fishing reel aimed at reducing the amount of play in the handle knob.

### BACKGROUND

As is well-known in the art, a handle knob for a fishing reel is typically mounted on a shaft located near the distal end of a handle arm. The handle knob is used for reeling in fishing line after casting. The handle knob is usually axially constrained onto the shaft by a rivet or a screw, or a similar fastening apparatus. Oftentimes, bearings or bushings are included between the knob and the shaft to reduce friction. In such cases, to avoid binding, the length of the internal geometry of the knob between the bearings, or bushings, cannot be longer than the distance between the bearings. Because such distance is shorter, there is always a gap provided between the screw and the bearing. This gap causes free axial play in the handle knob assembly. Such axial play can give an operator a sense of discomfort because play in the knob can make the handle feel wobbly and ineffective.

An example of a handle knob 5 of the prior art using this design is set forth in FIG. 1. As illustrated, the handle knob 5 may generally consist of a handle knob 10 attached to a handle arm 15 (a portion of which is illustrated) connected therewith by a shaft 20. The handle knob 10 may vary in both geometric shape and size, depending on the embodiment and design. Oftentimes, the design of the handle knob 10 may be adapted for different ergonomic grips. The shaft 20 may be connected using any known method as present in the art, such as a fastening apparatus, through a permanent fixture method, or any other method now known or has yet to be discovered. The handle knob 10 may further be coated or otherwise covered by a layer of rubber, leather, or other tactile texture coating 25 to aid in gripping and operating. The handle knob 10 may further comprise a cavity, hole, or other opening, such that the handle knob 10 may be placed over or on the shaft 20, in a manner such that the handle knob 10 at least partially surrounds the shaft 20. After positioning, the handle knob 10 can be constrained or otherwise affixed to the shaft 20 by a fastening apparatus, including but not limited to rivets, screws, or other known fasteners. By way of non-limiting example and as illustrated in FIG. 1, a screw 30 may be used to axially affix the handle knob 10 to the shaft 20.

As is further known in the art, bearings, bushings, or other elements are often provided and positioned between the knob handle 10 and the shaft 20 to reduce friction between the two components. By way of non-limiting example, the handle knob 5 includes a bearing 35 positioned around the screw 30 and in the space or cavity between the handle knob 10 and the shaft 20. In other words, the bearing 35 can be placed between the shaft 20 and the shoulder of the underside of the screw 30. However, to avoid binding, the length of the internal geometry of the knob handle 10 and the bearing 35 cannot extend past the width of the bearing 35.

Thus, there is a space or gap 40 provided between the screw 30 and the bearing 35. This gap 40 allows for free axial play in the handle knob assembly of the prior art 5. This free play can create a loose feel to the user and can further cause internal moving of parts and components within the handle knob 5 which can lead to part failure over time. In addition to the bearing 35 located near the screw 30, the prior art may additionally and/or optionally comprise a second bearing or bushing 45, located near the handle arm 15. This second bearing 45 may further aid in reducing friction in the knob handle 10.

Accordingly, a need exists for a handle knob assembly that reduces or eliminates free play found in the handle knob of a fishing reel. Further, a need exists for a solution to this problem that is cost effective in both labor and material costs.

### SUMMARY OF THE INVENTION

The present invention is directed toward a system for reducing or eliminating free play within the handle knob of a fishing reel. The system generally includes the addition of a biasing means for reducing or eliminating the space or gap between the bearing or bushing and the fastening apparatus (e.g., screw) within the handle knob. The present invention provides several methods and mechanisms for reducing or eliminating this gap, and thereby, reducing or eliminating the free play within the handle knob.

In the first embodiment of the present invention, one or more living springs extending from the interior of the housing of the handle knob can fit below the underside of the bearing. The springs can flex and provide an upward force upon the bearing, pushing the bearing against the underside of the screw head. The upward force biases the bearing against the screw head, reducing or eliminating the gap between the bearing and the screw, thereby reducing or eliminating free play within the handle knob.

A second embodiment of the present invention can also utilize one or more living springs for reducing or eliminating the gap between the bearing and the screw. In the second embodiment, the knob may additionally comprise a flange or lip. The lip can be offset from the bearing by some small amount, thus limiting the amount the spring can be compressed if an axial force is applied to the knob.

A third embodiment of the present invention utilizes the same general design of the second embodiment, but it also includes at least one embossment or protrusion extending from the interior of the housing of the handle knob. The protrusion can extend inwardly and interact with, and provide a radial force to, the bearing. When used in tandem with the springs, the bearing is acted upon by both an axial and a radial force, thereby firming up the connection and even further reducing free play within the handle knob.

A fourth embodiment of the present invention includes an elastomeric material formed around the knob. The elastomeric material may include a protrusion for interacting with a bottom bearing located at the bottom of the shaft. The flange creates a downward force upon the second bearing, thus constricting and limiting movement of the bearing. The elastomeric material further provides an upward force against the first bearing located at the top of the shaft and presses the bearing against the screw. This constant upward and downward pressure reduces the free play within the handle knob.

A fifth embodiment of the present invention uses a cap that can be placed over the head of the screw. The cap may be a permanent fixture, or alternatively it may be removably attached to the screw head. The cap provides a downward force against the outer race of the bearing, thereby causing the bearing outer to be axially constrained in the knob. A lip is also provided on the shaft, and the screw is tightened onto the inner race of the bearing such that the inner race of the bearing is axially constrained between the screw and the shaft. This preferably reduces the handle free play to only that which is present in the bearing itself.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1 is a cross-sectional view of a handle knob as known in the prior art;

FIG. 2A is a cross-sectional side view of a handle knob in accordance with one embodiment of the present invention;

FIG. 2B is a cross-sectional top view of a handle knob in accordance with the embodiment of the present invention as illustrated in FIG. 2A;

FIG. 3A is a cross-sectional side view of a handle knob in accordance with a second embodiment of the present invention;

FIG. 3B is a cross-sectional top view of the handle knob of FIG. 3A;

FIG. 4 is a cross-sectional side view of a handle knob in accordance with a third embodiment of the present invention;

FIG. 5A is a cross-sectional side view of a handle knob in accordance with a fourth embodiment of the present invention;

FIG. 5B is a cross-sectional side view of a handle knob in accordance with a fourth embodiment of the present invention; and

FIG. 6 is a cross-sectional side view of a handle knob in accordance with a fifth embodiment of the present invention.

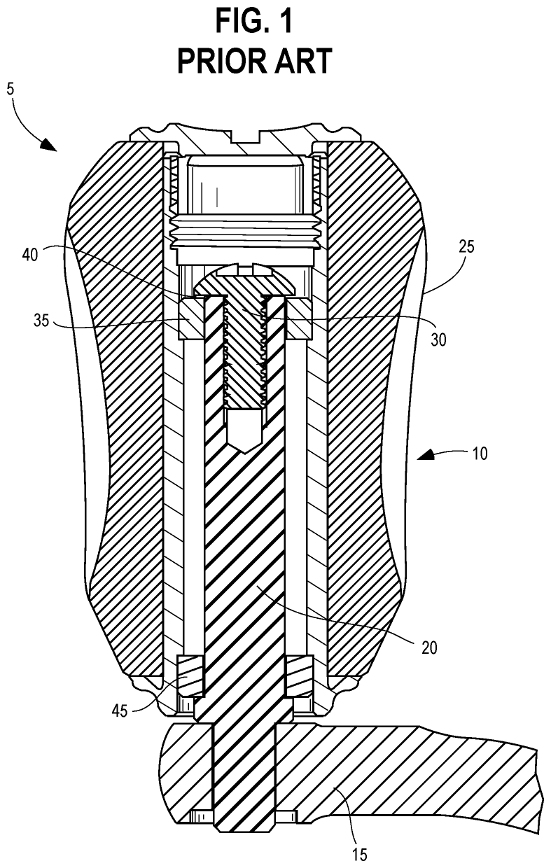

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is generally directed to a system for reducing or eliminating free play in a handle knob assembly for use with a fishing reel. Particularly, the present invention is directed to reducing or eliminating the gap or space between the fastening apparatus and the bearing or bushing located within the handle knob assembly. As described in greater detail herein, the present invention may utilize several mechanisms and methods of achieving this result, depending on the embodiment. The present invention provides a cost-effective solution, in that the solutions provided herein may be developed and applied in a manner that limits time, labor, and part costs.

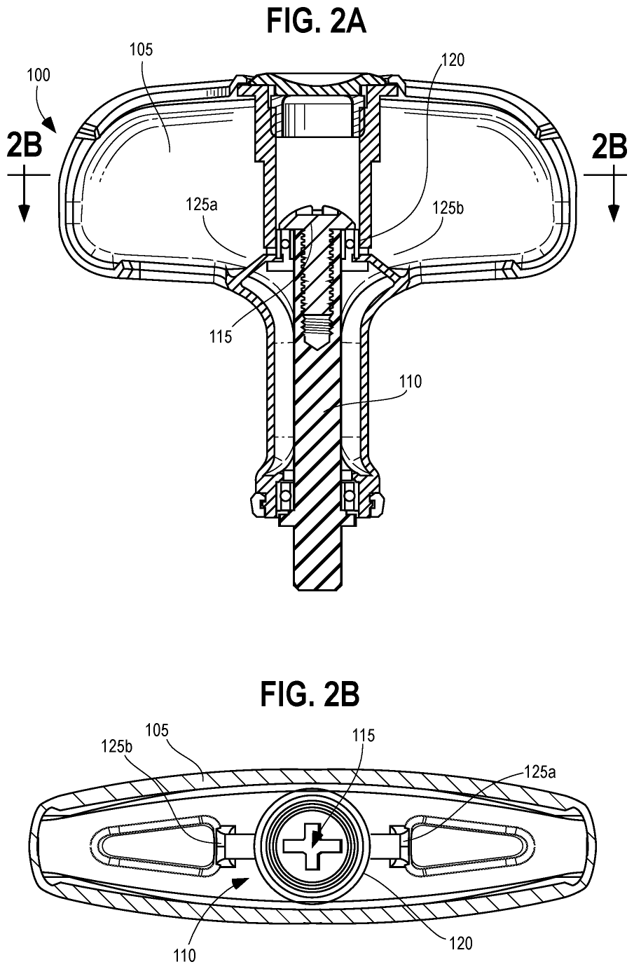

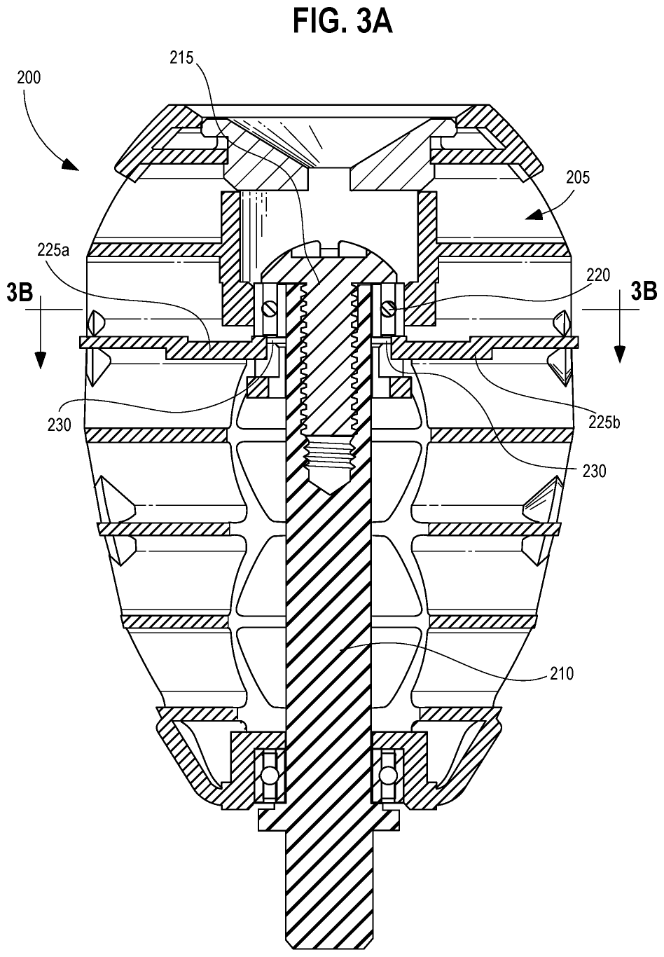

FIGS. 2A and 2B illustrate a first embodiment of a handle 100 with no free play. In one embodiment, the handle 100 may be generally constructed and manufactured using known methods in accordance to prior art handles, or new methods such as additive manufacturing. The handle 100 may comprise a handle knob 105, a handle arm (not shown), a shaft 110 for connecting the handle knob 105 to the handle arm, and a screw 115 or other fastening device for affixing the handle knob 105 to the shaft 110. As depicted in FIG. 2B, and by way of non-limiting example, the screw 115 may be a Philips head screw, but other designs or alternative fastening apparatuses may be used and incorporated. The handle 100 may further include a bushing or bearing 120 positioned between the underside shoulder of the screw 115 and the top of the shaft 110.

As further illustrated in FIG. 2A, the handle knob 105 may further comprise at least one active or “living” spring, positioned within the housing of the handle knob 105. One embodiment of the handle knob 105 may comprise two springs, spring 125a and spring 125b positioned circumferentially around the screw 115 and secured within the inside of the housing of the handle knob 105. In this embodiment, the spring 125a and the spring 125b may extend from an initial point in the housing of the handle knob 105 and extend to the space between the bearing 120 and the shaft 110, creating an interference fit on the bottom of the bearing 120. When positioned this way, the flexible force generated by the spring 125a and the spring 125b can cause an upward force of pressure to the bearing 120, and thereby push the bearing 120 against the underside of the screw 115. The upward force generated by the springs 125a, 125b can cause the bearing 120 to interact with and press against the underside shoulder of the screw 115. The interaction between the bearing 120 and the screw 115 generated by the spring 125a and the spring 125b can reduce, and even eliminate, the gap 40 that is present in the prior art.

As depicted in FIGS. 2A and 2B, the spring 125a and the spring 125b can be positioned on opposite sides of the screw 115, such that an even distribution of force and pressure can be applied to the screw 115. However, in alternate embodiments the spring 125a and the spring 125b may be positioned at any circumferential position around the screw 115. It will also be appreciated that in further embodiments, the handle knob 105 may comprise more or fewer living springs than as depicted in FIG. 2A. In such an embodiment, the springs may be positioned at varying points circumferentially around the screw 115. However, in such embodiments of the handle knob 105, the living springs 125 preferably pressure the bearing 120 against the underside of the screw 115, thus eliminating or reducing the gap 40 that is present in the prior art. By reducing or eliminating the gap 40, free play in the handle knob 105 is reduced and may even be eliminated.

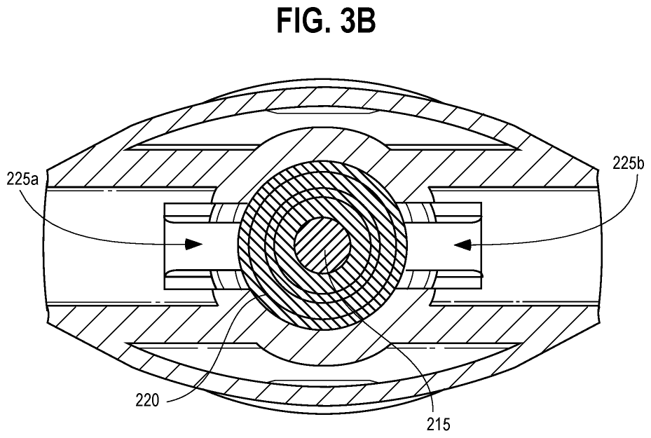

FIGS. 3A and 3B illustrate a second embodiment of a handle 200. In one embodiment, the handle 200 may be generally constructed in accordance to handles of the prior art or new methods such as additive manufacturing, and it may comprise a handle knob 205, a handle arm (not shown), a shaft 210 for connecting the handle knob 205 to the handle arm, and a screw 215 or other fastening device for affixing the handle knob 205 to the shaft 210. FIGS. 3A and 3B further illustrate an exemplary design and shape that the handle knob 205 may take in all embodiments of the present invention. Additionally, as depicted in FIG. 3A, and by way of non-limiting example, the screw 215 may be a flat head screw, but other designs or alternative fastening apparatuses may be used and incorporated. Like the handle knob 105, the handle knob 205 further may include a bushing or bearing 220 positioned between the underside shoulder of the screw 215 and the top of the shaft 210.

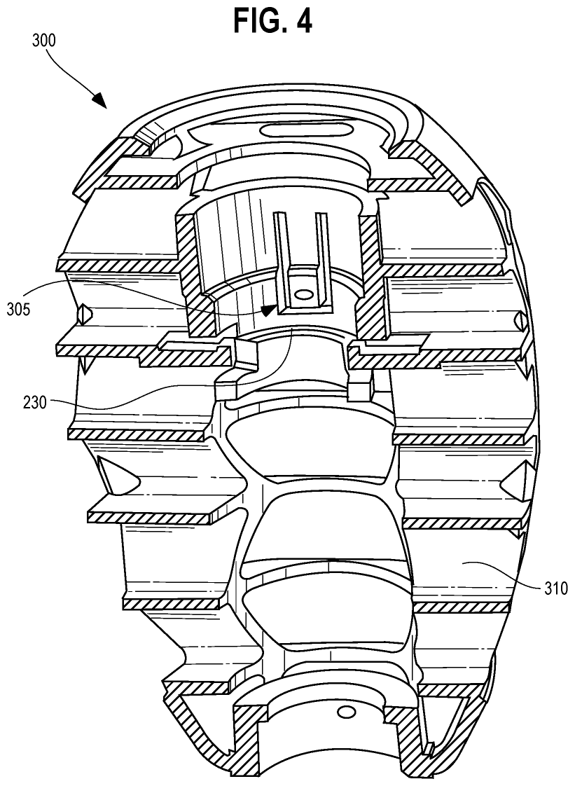

The handle knob 205 may further utilize a similar living spring design that is present in the handle knob 105, as described above. When utilizing a living spring design, the handle knob 205 may include two flexible springs, spring 225a and spring 225b positioned circumferentially around the screw 215. In contrast to the handle 100 described above, the knob 205 may consist of an alternate design, such that the knob 205 also may comprise a lip 230 or flange at an end proximate to the shaft 210 and the bearing 220. This lip 230 can also be seen incorporated in FIG. 4.

While the shape and design of the spring 225a, the spring 225b, and lip 230 may vary, depending on the embodiment, both the spring 225a and the spring 225b can still generate an upward flexible force against the bearing 220. The upward force generated by the spring 225a and the spring 225b forces the bearing 220 to interact and press against the underside shoulder of the screw 215. This upward pressure applied by the spring 225a and the spring 225b to the bearing 220 reduces and can even eliminate the gap 40 that is present in the prior art. Distinguishing from the first embodiment 100 described above, the lip 230 in the spring 225a and the spring 225b may be used to limit the range of motion of the bearing 220 against the springs 225a and 225b when an axial load is applied to the handle knob. Such a lip like the lip 230 could also be incorporated into the first embodiment.

As present in the first embodiment described above and as illustrated in FIGS. 3A and 3B, the spring 225a and the spring 225b can be positioned on opposite sides of the screw 215, such that an even distribution of force and pressure can be applied to the screw 215. However, in alternate embodiments the spring 225a and the spring 225b may be positioned at any circumferential position around the screw 215. It will also be appreciated that in further embodiments, the handle knob 205 may comprise more or fewer living springs than as depicted in FIGS. 3A and 3B. In such an embodiment, the springs may be positioned at varying points circumferentially around the screw 215. However, in all embodiments of the handle knob 205, the living springs provide a pressure to the bearing 220 pushing the bearing 220 against the underside of the screw 215, eliminating or reducing the gap 40 that is present in the prior art.

FIG. 4 illustrates a third embodiment of a handle 300 with no free play. In one embodiment, the handle 300 may be generally constructed in accordance to the handle 200 as described above. However, the handle 300 may further include at least one embossment or protrusion 305 extending inwardly from the interior housing of a knob handle 310. The protrusion 305 can be manufactured into the interior housing of the knob handle 310 during manufacturing or alternatively, can be added to the knob handle 310 after manufacturing. This protrusion 305 can be used to apply a radial force to the bearing, so that there is limited or no radial movement of the bearing. This radial force generated by the protrusion 305 when used in tandem with the axial pressure applied by the flexible springs firms up the connection on the bearing. With both an axial and radial force applied to the bearing, play in the handle 300 is greatly reduced and can even be eliminated. The handle 300 may be manufactured in a number of ways but is preferably manufactured using an additive manufacturing process.

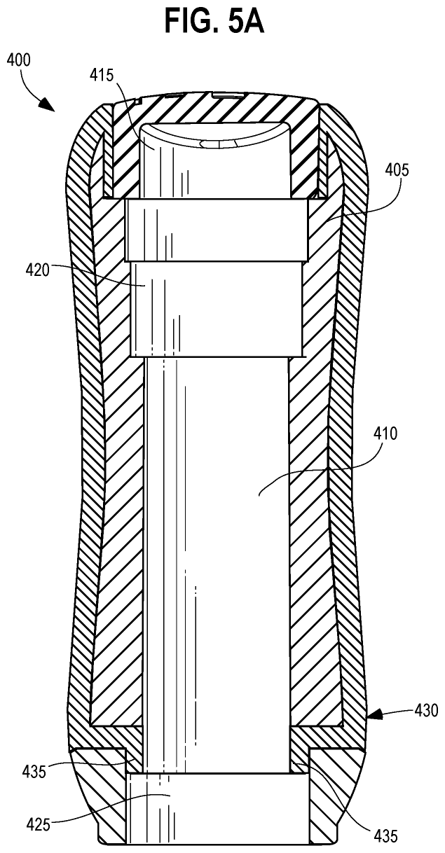

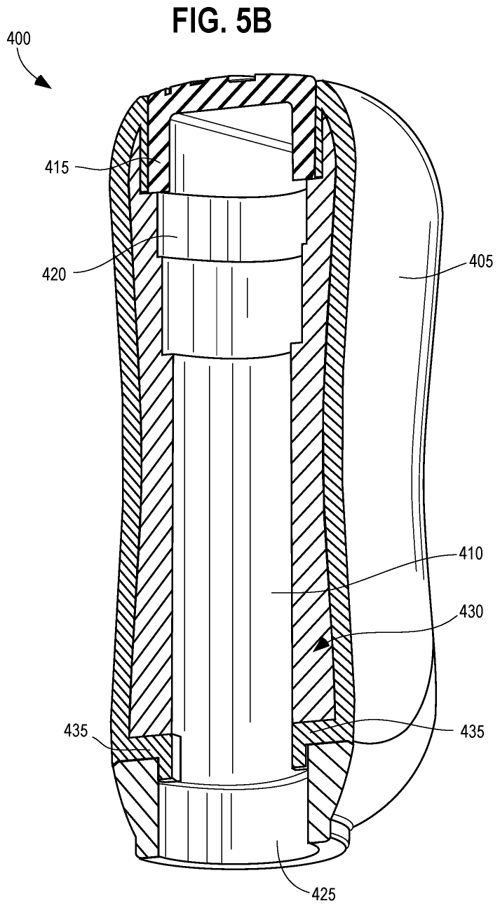

FIGS. 5A and 5B illustrate a fourth embodiment of a handle 400 in which free play may be reduced without the use of living springs. In one embodiment, the handle 400 may comprise a handle knob 405, a handle arm (not shown), a shaft 410 for connecting the handle knob 405 to the handle arm, and a screw 415 or other fastening device for affixing the handle knob 405 to the shaft 410. Like the handle knob 105, the handle knob 405 may further include a bushing or bearing 420 positioned under the shoulder of the screw 415 and around the top of the shaft 410. The handle knob 405 may further include a second bearing 425 located at the bottom of the shaft 410 near the handle arm.

The handle knob 405 may additionally and further comprise an elastomeric or rubber material 430, that at least partially surrounds the shaft 410. The elastomeric material 430 may be used as an aid by the operator in gripping and handling the handle knob 405. Additionally, the elastomeric material 430 may further be used for reducing free play within the handle knob 405. As illustrated in FIGS. 5A and 5B, the elastomeric material 430 may include at least one protrusion 435 which may come in direct contact with the second bearing 425, located near the handle arm. Because the second bearing 425 is constricted by both the flange 435 and the elastomeric material 430, force applied by the flange 435 can keep the second bearing 425 in position and limit free play.

In addition to the downward force generated by the flange 435 and the elastomeric material 430 as applied to the second bearing 425, the elastomeric material 430 can further apply an upward force and pressure to the bearing 420, pushing the bearing 420. This upward force can cause the bearing 420 to press up against screw 415. With pressure applied to both the bearing 420 and the second bearing 425, free play is limited or eliminated within the handle knob 405.

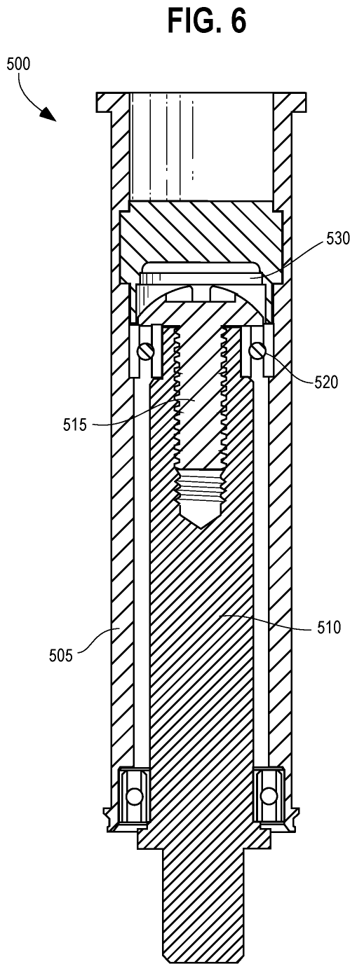

FIG. 6 illustrates a fifth embodiment of a handle 500, demonstrating an embodiment in which free play may be reduced without the use of living springs or an elastomeric material. In one embodiment, the handle 500 may include a handle knob 505, a handle arm (not shown), a shaft 510 for connecting the handle knob 505 to the handle arm, and a screw 515 or other fastening device for affixing the handle knob 505 to the shaft 510. As further depicted in FIG. 6, and by way of non-limiting example, the screw 515 may be a flat head screw, but other designs or alternative fastening apparatuses may be used and incorporated. As present in this first embodiment, the handle knob 505 may further include a bushing or bearing 520 positioned between the underside shoulder of the screw 515 and a lip near the top of the shaft 510. As illustrated in FIG. 6, the handle knob 505 does not include a gap 40 or spacing between the screw 515 and the bearing 520 that is present in the prior art.

As illustrated, the handle knob with no free play may further and additionally include a cap 530 or other apparatus which may be placed over the top of the screw 515. The shape of the cap 530 may vary based on the embodiment of the handle knob with no free play 500 and the screw 515, but it will be appreciated that the cap 530 may be designed such that it is compatible with the shape of the handle knob 505. Once placed, the cap 530 may be optionally secured in place using any known mechanical, adhesive, or other means. Alternatively, the cap 530 may be removably secured in such a manner, so that it may be placed and removed when desired. When placed over the screw 515, the cap 530 may provide a downward force or pressure to the outer race of bearing 520 in a way that presses the axially captures the outer race against the top of the handle knob 505, reducing or eliminating the gap 40 that is present in the prior art. This reduction or elimination of the gap 40 can further reduce or eliminate the free play within the knob handle 505.

From the foregoing, it will be seen that this invention is one well adapted to attain all the ends and objectives hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A handle, the handle comprising:
a handle knob;
a handle arm in mechanical connection with the handle knob;
a shaft having a first end and a second end, wherein the handle knob is connected to the first end of the shaft, and the handle arm connected at a second end of the shaft;
a fastening device for affixing the handle knob to the shaft;
a bearing positioned between the fastening device and the shaft; and
a biasing means for applying an axial force against the bearing.

2. The handle of claim 1, wherein the handle knob includes a lip surrounding the shaft and abutting the bearing.

3. The handle of claim 1, wherein the biasing means is formed integrally to an interior of the handle knob.

4. The handle of claim 1, wherein the handle knob is made of an elastomeric material.

5. The handle of claim 1, wherein the handle knob includes at least one protrusion extending inwardly from an interior housing of the knob handle, the at least one protrusion abutting the first bearing.

6. The handle of claim 1, wherein the handle knob further includes a plastic core and an elastomeric over-molding.

7. The handle of claim 6, wherein the biasing means is integral to the elastomeric over-molding.

8. The handle of claim 1, wherein the biasing means is a spring.

9. The handle of claim 1, wherein the handle includes a cap on the fastening device, the cap applying a downward pressure on the fastening device and the bearing to reduce axial free play in the handle.

10. The handle of claim 1, wherein the handle knob is made by an additive manufacturing process.

11. A handle, the handle comprising:
a handle knob for a fishing reel, the handle knob including:
a first pocket at a first end;
a first bearing received in the first pocket; and
a biasing means for applying an axial force against the first bearing.

12. The handle of claim 11, wherein the handle knob further includes a second pocket at a second end.

13. The handle of claim 12, wherein the handle knob further includes a second bearing received in the second pocket.

14. The handle of claim 11, wherein the biasing means is formed integrally to an interior of the handle knob.

15. The handle of claim 11, wherein the handle knob is made of an elastomeric material.

16. The handle of claim 11, wherein the handle knob includes at least one protrusion extending inwardly from an interior housing of the knob handle, the at least one protrusion abutting the first bearing.

17. The handle of claim 11, wherein the handle knob further includes a plastic core and an elastomeric over-molding.

18. The handle of claim 17, wherein the biasing means is integral to the elastomeric over-molding.

19. The handle of claim 11, wherein the handle includes a cap on the fastening device, the cap applying a downward pressure on the fastening device and the bearing to reduce axial free play in the handle.

20. The handle of claim 11, wherein the biasing means is a spring.
